(19) United States
(12) Patent Application Publication
(10) Pub. No.: US 2007/0097015 A1
(43) Pub. Date: May 3, 2007

(54) Display device

(76) Inventors: Karl-Heinz Ronkholz, Krefeld (DE); Rolf Aengenendt, Krefeld (DE)

Correspondence Address: FISH & RICHARDSON PC, P.O. BOX 1022, MINNEAPOLIS, MN, 55440-1022, US

(21) Appl. No.: 11/264,822

(22) Filed: Nov. 1, 2005

(51) Int. Cl. G09G 5/00

(52) U.S. Cl. 345/1.1

(57) ABSTRACT

A display device for so-called facade displays is proposed which comprises several supports that can be affixed to the facade of an edifice, in particular a building, on the outside or the inside; a plurality of groups of light-emitting diodes that are provided on the several supports and serve as picture points of the display device; and a control unit for activating the plurality of the groups of light-emitting diodes. The display device distinguishes itself by the fact that the several supports are each formed as an elongated profile body, which comprises a recess extending in the longitudinal direction of the profile body; that the plurality of groups of light-emitting diodes are mounted on several circuit boards, the several circuit boards each being integrated or incorporated in a protective mass; and that the several circuit boards are inserted in such a way into the recesses of the several supports that the plurality of groups of light-emitting diodes project at least partly from the recesses or face at least the outer side of the respective support.

### BACKGROUND OF THE INVENTION

1. Field of the Invention

The present invention relates to a display device, in particular a display device for a so-called facade display.

2. Technical Background

A facade display is known from DE 40 39 034 A1, in which the facade of the building remains unchanged and that can be installed at relatively low cost. The display device disclosed in DE 40 39 034 A1 uses at least part of the front of a building with regularly disposed windows or groups of windows, which are used as picture points of the display, and light sources allocated to each window that are mounted in or on the building, which can be selectively switched. As is represented in the single Fig. of this document, the current time is displayed in digital writing by means of the selectively illuminated windows of the front of the building. Since the individual picture points are in each case formed by a complete window in this facade display, the possibilities of the information to be displayed with this facade display are limited.

Moreover, DE 100 26 285 A1 of the present inventors describes a facade display, in which a plurality of illumination units can be affixed to the facade of a building for instance by means of a reticulate wire mesh. Due to this, the illumination units can be flexibly disposed on the facade of the building so that a great variability as regards the design and the display possibilities is ensured.

In a further development of the display device known from DE 100 26 285 A1, DE 100 64 534 A1 of the present inventors suggests a display device for facade displays, in which the groups of light-emitting diodes that serve as picture points are affixed on several supports which, in turn, are mounted on a fastening device affixed to the facade of a building. For instance, the supports are designed in the form of lamellae which are affixed to the fastening device like a sunshade blind.

Similar constructions with special support systems are also disclosed by EP 0 997 865 A2 and EP 1 293 955 A2.

### SUMMARY OF THE INVENTION

The present invention is based on the object of providing a display device for facade displays which, on the one hand, ensures a high flexibilitay of the display possibilities and, at the same time, a secure and durable attachment of the groups of light-emitting diodes serving as picture points is ensured.

This object is attained by a display device comprising several supports which, for instance, may be affixed to the facade of a building; a plurality of groups of light-emitting diodes which are provided on the several supports and serve as picture points of the display device; and a control unit for activating the plurality of groups of light-emitting diodes. The several supports are each formed as an elongated profile body which has a recess extending in the longitudinal direction of the profile body. The plurality of groups of light-emitting diodes are mounted on several circuit boards, the several circuit boards each being integrated and/or incorporated in a protective mass. The several circuit boards are inserted into the recesses of the several supports so that the plurality of the groups of light-emitting diodes project at least party from the recesses or face at least the outer side of the respective support.

The display device of the present invention combines the simple and flexible attachment of a plurality of groups of light-emitting diodes that serve as picture points to a facade by means of several supports with a safe and durable attachment of the groups of light-emitting diodes and their electronics components required for the activation on the circuit boards by incorporating the circuit boards in the protective mass and introducing them into the longitudinal recesses of the supports.

In a further development of the invention each of the several supports also comprises at least one fastening device with which the supports can be mounted on a support frame, which, in turn, is affixed to the facade. The several supports may be mounted on the support frame with the at least one fastening device e.g. by means of clamping, interference fit, bolting, gluing, welding or the like.

In a further development of the invention several circuit boards are each disposed in series in the recess of a support. In this case, the several circuit boards should be coupled in the recess of a support by means of connecting elements for electrical connection and data transmission, the connecting elements being preferably pin-and-socket connectors and the circuit boards having preferably corresponding terminals in the area of their front sides.

In a still further development of the invention the circuit boards have terminals for electric connection with and data transmission from an external control unit in the area of at least one of their front sides.

Preferably, the several supports are formed in the shape of lamellae which may e.g. also be mounted in the manner of a sunshade blind in horizontal or vertical alignment, but basically in an optional alignment or even differents alignments. The several supports may be mountable in such a way that they are pivotable about their longitudinal axes between an operating position and a non-operating position of the display device or also of the sunshade blind device.

The distance between the supports, on the one hand, and the distance between the groups of light-emitting diodes of the circuit boards, on the other, may be optionally chosen in such a way that the are equal to or different from each other.

### BRIEF DESCRIPTION OF THE DRAWINGS

The above and further features and advantages of the invention can be better understood from the following description of a preferred non-limiting example of embodiment with reference to the attached drawings, in which

FIG. 1 shows a greatly schematic front view of the facade of a building with a display device according to the present invention;

FIG. 2 shows a cross-section through a support of the display device with attached groups of light-emitting diodes according to a preferred example of embodiment of the present invention;

FIG. 3 shows a side view of the circuit boards built into the support of FIG. 2 in accordance with a preferred example of embodiment of the present invention; and

FIG. 4 shows an enlarged view of a detail of the cutout X of FIG. 3.

### PREFERRED EMBODIMENT OF THE INVENTION

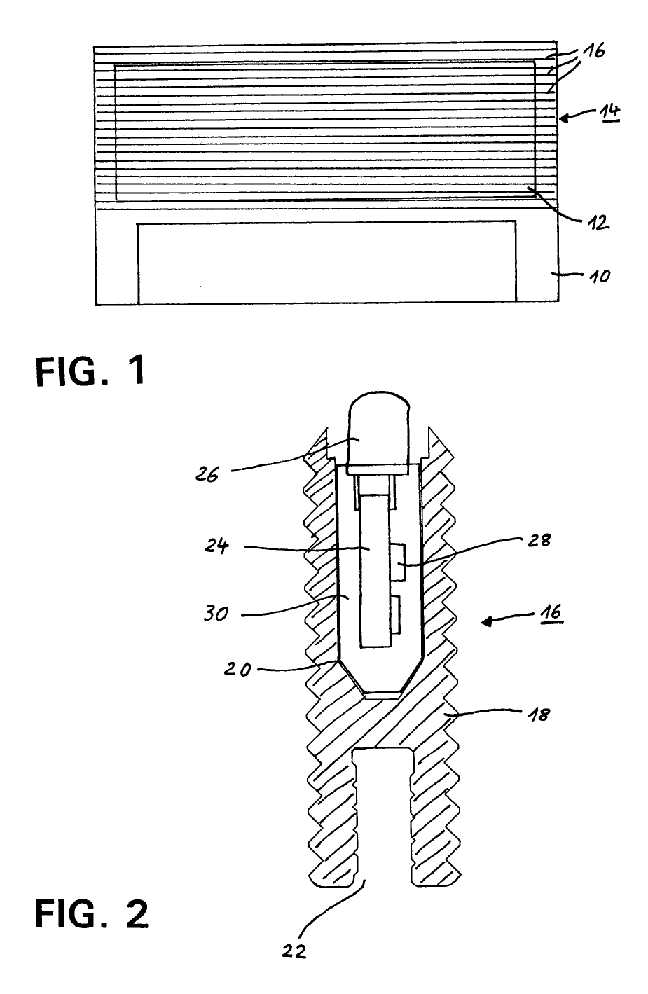

As is represented in FIG. 1 in a greatly simplified fashion, the display device 14 of the present invention is in particular suited as a so-called facade display which can be mounted on a facade 10 of an edifice, in particular a building, e.g. in front of a large-surface window front 10, to display information. Basically, optional information can be represented on the facade display, in particular both alphanumerical and graphical symbols, both stills, light writing and real time videos and the like. The display device 14 of the invention is of course not restricted to specific types or sizes of edifices or to the presence of large-surface window fronts 12, even if the invention is explained in greater detail in the following taking the facade of a building with a large-surface window front as an example.

The display device 14 according to the invention comprises several supports 16 which are provided in a horizontal alignment on the facade of the building in the illustration of FIG. 1. Optionally it is also conceivable to attach these supports 16 to the facade 10 in vertical alignment. However, basically it is possible to mount the supports on the facade 10 at an optional angle or even in different alignment.

The individual supports 16 are formed as elongate profile bodies 18 e.g. in the form of lamellae like e.g. a sunshade blind. The profile bodies 18 which are to be affixed to the outer side or inner side of the facade 10 of the building consist e.g. of a metal such as aluminum and/or its alloy or a weather-resistant synthetic material.

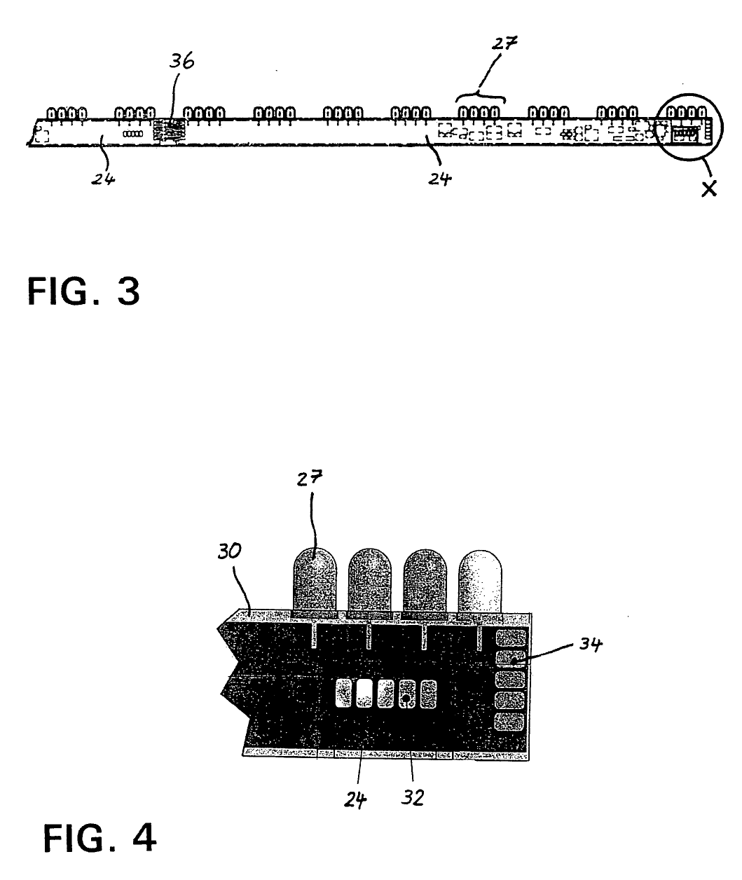

As is schematically represented in FIG. 2, the elongate profile body 18 has a first recess 20 at a narrow longitudinal side, which extends in the longitudinal direction of the profile body 18 substantially along its entire length. The first recess 20 is provided on the longitudinal side of the profile body 18, which does not face the facade 10 of the building in the operating position of the display device 14 so that the opening of the first recess 20 is directed away from the facade. This first recess 20 serves for receiving a circuit board 24 with several light-emitting diodes 26 and the electronics components 28 which will be explained in greater detail below by means of FIGS. 3 and 4. As can already be seen in FIG. 2 the circuit board 24 is incorporated and/or integrated in a protective mass 30, and the light-emitting diodes 26 should project at least partly from the first recess 20 of the profile body 18 or at least face the outer side of the profile body 18. The circuit board 24 with the light-emitting diodes 26 that is integrated in the protective mass 30 is firmly inserted or pushed into the first recess (e.g. by means of interference fit, gluing, locking, integration or the like). The protective mass consists e.g. of an electrically insulated material that is resistant against environmental influences.

The profile body 18 comprises e.g. a second recess 22 on the narrow longitudinal side which does not face the first recess 20, i.e. that faces the facade 10 of the building in the operating position of the display device 14. The support 16 can be attached to a support frame (not shown) by means of this second recess 22, e.g. by means of clamping, bolting or interference fit, the support frame being in turn attached to the facade 10 of the building. The support may also comprise instead of or in addition to the second recess 22 other elements as a fastening device, by means of which it can be mounted on the support frame by means of clamping, interference fit, bolting, gluing, welding or the like. Moreover, the location of the fastening device 22 is not restricted to the longitudinal side of the profile body 18 and must also not extend along the entire length of the profile body. In an especially advantageous development the supports 16 can thus be mounted on the support frame (not shown) and/or the support frame can be designed and/or disposed in such a way that the supports 16 are pivotable about their longitudinal axes between an operating position and a non-operating position of the display device 14 and/or the sunshade device.

In addition to the electronics components 28 required for the activation of the light-emitting diodes 26, several groups 27 of light-emitting diodes are provided on the circuit board 24 as is illustrated by the representation of FIG. 3. Each group 27 of light-emitting diodes consists of several preferably different-colored light-emitting diodes 26 so that picture points of optional colors can be formed. However, the present invention is not only restricted to such groups 27 of light-emitting diodes, but the groups 27 of light-emitting diodes may also only comprise one to three light-emitting diodes 26 or more than four light-emitting diodes 26, they may comprise different numbers of light-emitting diodes 26 and they must not contain any light-emitting diodes of different colors.

The distance between the individual groups 27 of light-emitting diodes on a circuit board 24 may either be chosen as being the same as or different to the distance of the supports 16 with respect to each other. In other words, the distance of the picture points in the horizontal and vertical directions may be optionally selected symmetrically or asymmetrically, which must, of course, be correspondingly taken into consideration when activating the groups 27 of light-emitting diodes by means of a control unit (not shown). The variability of the display device 14 according to the invention is still intensified by the basically optionally angular or even different alignment of the individual supports with respect to each other.

As is represented in the enlarged cutout X in FIG. 4, each circuit board 24 comprises several first terminals 32 in the area of its one front side (preferably on both front sides). These first terminals 32 serve for the coupling of the circuit boards 24 of the supports to the control unit (not shown) for the electrical connection and data transmission.

Moreover, the circuit board comprises further terminals 34 in the area of its front side (preferably on both front sides). These further terminals 34 serve for the coupling of several circuit boards 24 for the electrical connection and data transmission, which are disposed in series one behind the other in a support 16. The coupling is implemented via a suitable connecting element 36 such as e.g. a pin-and-socket connector. As is outlined in FIG. 3, several circuit boards 24 can thus be connected with each other in the longitudinal direction and built into a support 16. This is advantageous since the lengths of the circuit boards 24 are generally limited for manufacturing and handling reasons. However, it is likewise possible within the framework of the invention to provide the first terminals 32 and the further terminals 34 as joint terminals 32, 34.

What is claimed is:

1. A display device comprising
several supports which can e.g. be mounted on a facade of an edifice;
a plurality of groups of light-emitting diodes which are provided on several supports and serve as picture points of the display device; and
a control unit for activating said plurality of groups of light-emitting diodes,
characterized in that
said several supports are each formed as an elongated profile body, which has a recess extending in the longitudinal direction of said profile body;
said plurality of groups of light-emitting diodes are mounted on several circuit boards, said several circuit boards each being integrated in a protective mass, and
said several circuit boards are inserted into the recesses of said several supports in such a way that said plurality of groups of light-emitting diodes project at least partially from said recesses or face at least the outer side of the respective support.

2. A display device according to claim 1, wherein each of said several supports also comprises at least one fastening device, with which said supports can be mounted on a support frame, which in turn is affixed to said facade of an edifice.

3. A display device according to claim 2, wherein said several supports are mountable by said at least one fastening device on said support frame by means of clamping, interference fit, bolting, gluing, welding or the like.

4. A display device according to claim 1, wherein in said recess of a support several circuit boards are disposed in series each.

5. A display device according to claim 4, wherein said several circuit boards in the recess of a support are coupled by means of connection elements for electrical connection and data transmission.

6. A display device according to claim 5, wherein said connection elements are pin-and-socket connectors and said circuit boards have corresponding terminals in the area of their front sides.

7. A display device according to claim 1, wherein said circuit boards have terminals for electric connection to and data transmission from the control unit in the area of at least one of their front sides.

8. A display device according to claim 1, wherein said several supports are formed in the shape of lamellae which can be mounted in a horizontal, vertical or angular alignment.

9. A display device according to claim 1, wherein the distance between said supports and the distance between said groups of light-emitting diodes of said circuit boards are optionally chosen to be equal or different.

10. A display device according to claim 1, wherein said several supports can be mounted in such a way that they are pivotable about their longitudinal axes between an operating position and a non-operating position of said display device and/or a sunshade device.

11. A display device comprising:
several supports which can e.g. be mounted on a facade of an edifice, said several supports being designed in the shape of lamellae which can be mounted in a horizontal, vertical or angular alignment;
a plurality of groups of light-emitting diodes which are provided on several supports and serve as picture points of said display device; and
a control unit for activating said plurality of groups of light-emitting diodes,
characterized in that
said several supports are each formed as an elongated profile body, which has a recess extending in the longitudinal direction of said profile body;
said plurality of groups of light-emitting diodes are mounted on several circuit boards, said several circuit boards each being integrated in a protective mass, and
said several circuit boards are inserted into the recesses of the several supports in such a way that said plurality of groups of light-emitting diodes project at least partially from said recesses or face at least the outer side of the respective support.

12. A display device according to claim 11, wherein said several supports can be mounted in such a way that they are pivotable about their longitudinal axes between an operating position, and a non-operating position of said display device and/or a sunshade device.
